(19) United States
(12) Patent Application Publication
(10) Pub. No.: US 2024/0272944 A1
(43) Pub. Date: Aug. 15, 2024

(54) COMPUTING TASK ALLOCATION FOR COMPLEX MULTI-TASK PROCESSES

(71) Applicant: Optum Services (Ireland) Limited, Dublin (IE)

(72) Inventors: Alan COOKE, Dublin (IE); Jan Andre JANSMA, Meath (IE)

(21) Appl. No.: 18/166,719

(22) Filed: Feb. 9, 2023

(51) Int. Cl. G06F 9/48; G06F 9/38

(52) U.S. Cl. CPC G06F 9/4887; G06F 9/3838

(57) ABSTRACT

Various embodiments of the present disclosure provide multi-task process orchestration techniques for efficiently allocating computing tasks across multiple disparate computing resources. The orchestration techniques include leveraging an optimization model to generate an optimal processing decision for an individual computing task of a multi-task process. The optimal processing decision is based on the individual computing task and a plurality of processing environments for the multi-task process. The plurality of processing environments includes a local processing environment and a remote processing environment and the optimal processing decision identifies the local processing environment or the remote processing environment as an optimal processing environment for the individual computing task. The performance of the individual computing task is initiated at one of the local or remote processing environments based on the optimal processing decision.

### BACKGROUND

Various embodiments of the present disclosure address technical challenges related to processing complex multi-task processes given limitations of existing task orchestration techniques. Existing task orchestration techniques, or load balancers, may distribute different multi-task processes among different processing environments to execute the multi-task processes in parallel. Such techniques may allocate one “local” processing environment for executing each computing task of a multi-task process. However, multi-task processes vary in complexity. This causes complex multi-task processes to overload some processing environments while other processing environments, assigned to execute less complex multi-task processes, are underutilized. This results in processing inefficiencies that degrade the performance and execution times for executing complex multi-task processes. Various embodiments of the present disclosure make important contributions to various existing task orchestration approaches by addressing these technical challenges.

### BRIEF SUMMARY

Various embodiments of the present disclosure disclose task orchestration techniques for improved multi-task process execution across multiple compute instances. Conventional task orchestration techniques allocate one compute instance for a respective multi-task process without consideration of the individual computing tasks of the multi-task process. This leads to processing inefficiencies for various computing systems. The present disclosure provides orchestration techniques that leverage an optimization model to individually analyze and orchestrate the execution of each computing task within a multi-task process across different compute instances. The optimization model may be trained to generate an optimal processing decision for a respective computing task of the multi-task process. The optimal processing decision may identify whether the computing task should be processed in a local processing environment or a remote processing environment. During execution time, the optimal processing decisions may be generated for each computing task of a multi-task process to facilitate the intelligent distribution of individual components of a multi-task process among local and remote processing environments. In this way, using the task orchestration techniques of the present disclosure, individual components of multi-task processes, of varying complexity, may be intelligently distributed to improve the allocation of available processing resources.

In some embodiments, a computer-implemented method comprises generating, by one or more processors and using an optimization model, an optimal processing decision for an individual computing task of a multi-task process, wherein: (a) the optimal processing decision is based on the individual computing task and a plurality of processing environments for the multi-task process, (b) the plurality of processing environments comprises a local processing environment and a remote processing environment, and (c) the optimal processing decision identifies the local processing environment or the remote processing environment as an optimal processing environment for the individual computing task; and initiating, by the one or more processors, the performance of the individual computing task based on the optimal processing decision.

In some embodiments, a computing apparatus comprises a memory and one or more processors communicatively coupled to the memory. The one or more processors are configured to generate, using an optimization model, an optimal processing decision for an individual computing task of a multi-task process, wherein: (a) the optimal processing decision is based on the individual computing task and a plurality of processing environments for the multi-task process, (b) the plurality of processing environments comprises a local processing environment and a remote processing environment, and (c) the optimal processing decision identifies the local processing environment or the remote processing environment as an optimal processing environment for the individual computing task; and initiate the performance of the individual computing task based on the optimal processing decision.

In some embodiments, one or more non-transitory computer-readable storage media include instructions that, when executed by one or more processors, cause the one or more processors to: generate, using an optimization model, an optimal processing decision for an individual computing task of a multi-task process, wherein: (a) the optimal processing decision is based on the individual computing task and a plurality of processing environments for the multi-task process, (b) the plurality of processing environments comprises a local processing environment and a remote processing environment, and (c) the optimal processing decision identifies the local processing environment or the remote processing environment as an optimal processing environment for the individual computing task; and initiate the performance of the individual computing task based on the optimal processing decision.

### BRIEF DESCRIPTION OF THE DRAWINGS

FIG. 1 illustrates an example computing system in accordance with one or more embodiments of the present disclosure.

FIG. 2 is a schematic diagram showing a system computing architecture in accordance with some embodiments discussed herein.

FIG. 3 is a dataflow diagram showing example data structures for intelligently executing a multi-task process in accordance with some embodiments discussed herein.

FIG. 4A is an operational example of a multi-task process orchestration scheme leveraging local processing environments in accordance with some embodiments discussed herein.

FIG. 4B is an operational example of a multi-task process orchestration scheme leveraging local and remote processing environments in accordance with some embodiments discussed herein.

FIG. 5 is an operational example of a task allocation scheme in accordance with some embodiments discussed herein.

FIG. 6 is an operational example showing example training techniques for training the optimization model in accordance with some embodiments discussed herein.

FIG. 7 is a flowchart showing an example of a process for intelligently executing a computing task in accordance with some embodiments discussed herein.

FIG. 8 is a flowchart showing an example of a process for generating a process result for a multi-task process in accordance with some embodiments discussed herein.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that the present disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not necessarily indicate being based only on or based solely on the referenced element or elements unless so indicated. Like numbers refer to like elements throughout.

### I. Computer Program Products, Methods, and Computing Entities

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together, such as in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In some embodiments, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically-configured machines performing the steps or operations specified in the block diagrams and flowchart illustrations. Accordingly, the block diagrams and flowchart illustrations support various combinations of embodiments for performing the specified instructions, operations, or steps.

### II. Example Framework

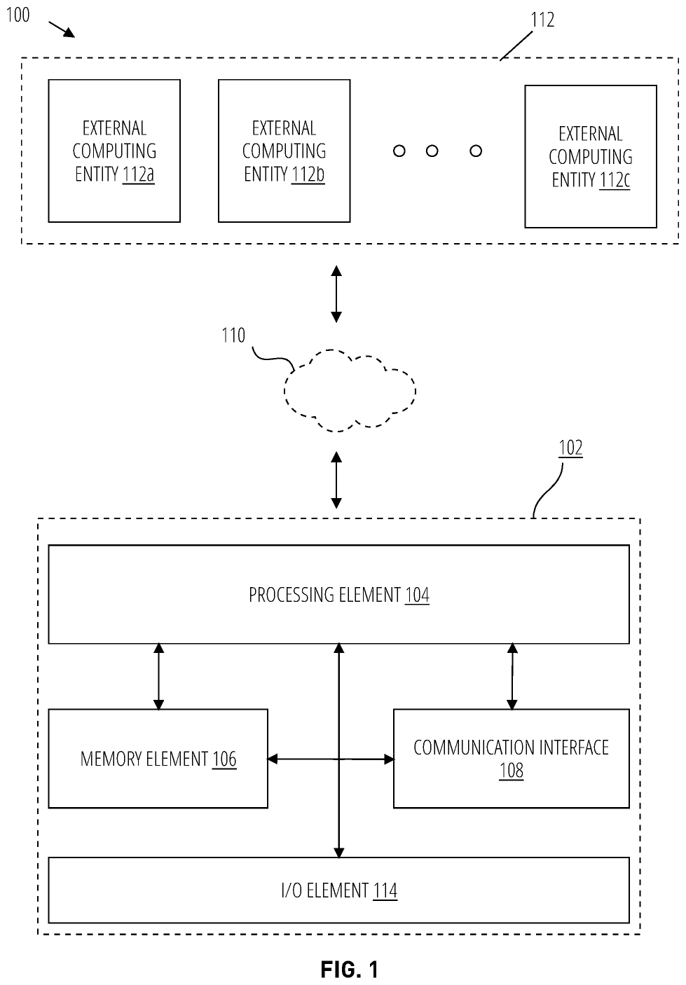

FIG. 1 illustrates an example computing system 100 in accordance with one or more embodiments of the present disclosure. The computing system 100 may include a predictive computing entity 102 and/or one or more external computing entities 112a-c communicatively coupled to the predictive computing entity 102 using one or more wired and/or wireless communication techniques. The predictive computing entity 102 may be specially configured to perform one or more steps/operations of one or more techniques described herein. In some embodiments, the predictive computing entity 102 may include and/or be in association with one or more mobile device(s), desktop computer(s), laptop(s), server(s), cloud computing platform(s), and/or the like. In some example embodiments, the predictive computing entity 102 may be configured to receive and/or transmit one or more datasets, objects, and/or the like from and/or to the external computing entities 112a-c to perform one or more steps/operations of one or more techniques (e.g., task orchestration techniques, training techniques, etc.) described herein.

The external computing entities 112a-c, for example, may include and/or be associated with one or more data centers, call centers, and/or any other external entity that may be configured to receive, store, and/or process multi-task processes and/or one or more portions thereof (e.g., computing tasks, etc.). The data centers, for example, may be associated with one or more data repositories storing historical, simulated, and/or real time input data (e.g., multi-task processes, dependency graphs, etc.) that may, in some circumstances, be processed by the predictive computing entity 102 to (i) generate an optimal processing decision for a computing task of a multi-task process, and/or (ii) train an optimization model that may be leveraged to generate the optimal processing decision. In some embodiments, one or more of the external computing entities 112a-c may include one or more data processing entities that may receive, store, and/or have access to training data for machine learning models. The data processing entities, for example, may maintain a training datastore with evaluation data and/or one or more portions of historical, simulated, and/or real-time training input data.

The predictive computing entity 102 may include, or be in communication with, one or more processing elements 104 (also referred to as processors, processing circuitry, digital circuitry, and/or similar terms used herein interchangeably) that communicate with other elements within the predictive computing entity 102 via a bus, for example. As will be understood, the predictive computing entity 102 may be embodied in a number of different ways. The predictive computing entity 102 may be configured for a particular use or configured to execute instructions stored in volatile or non-volatile media or otherwise accessible to the processing element 104. As such, whether configured by hardware or computer program products, or by a combination thereof, the processing element 104 may be capable of performing steps or operations according to embodiments of the present disclosure when configured accordingly.

In one embodiment, the predictive computing entity 102 may further include, or be in communication with, one or more memory elements 106. The memory element 106 may be used to store at least portions of the databases, database instances, database management systems, data, applications, programs, program modules, scripts, source code, object code, byte code, compiled code, interpreted code, machine code, executable instructions, and/or the like being executed by, for example, the processing element 104. Thus, the databases, database instances, database management systems, data, applications, programs, program modules, scripts, source code, object code, byte code, compiled code, interpreted code, machine code, executable instructions, and/or the like may be used to control certain aspects of the operation of the predictive computing entity 102 with the assistance of the processing element 104.

As indicated, in one embodiment, the predictive computing entity 102 may also include one or more communication interfaces 108 for communicating with various computing entities, e.g., external computing entities 112a-c, such as by communicating data, content, information, and/or similar terms used herein interchangeably that may be transmitted, received, operated on, processed, displayed, stored, and/or the like.

The computing system 100 may include one or more input/output (I/O) element(s) 114 for communicating with one or more users. An I/O element 114, for example, may include one or more user interfaces for providing and/or receiving information from one or more users of the computing system 100. The I/O element 114 may include one or more tactile interfaces (e.g., keypads, touch screens, etc.), one or more audio interfaces (e.g., microphones, speakers, etc.), visual interfaces (e.g., display devices, etc.), and/or the like. The I/O element 114 may be configured to receive user input through one or more of the user interfaces from a user of the computing system 100 and provide data to a user through the user interfaces.

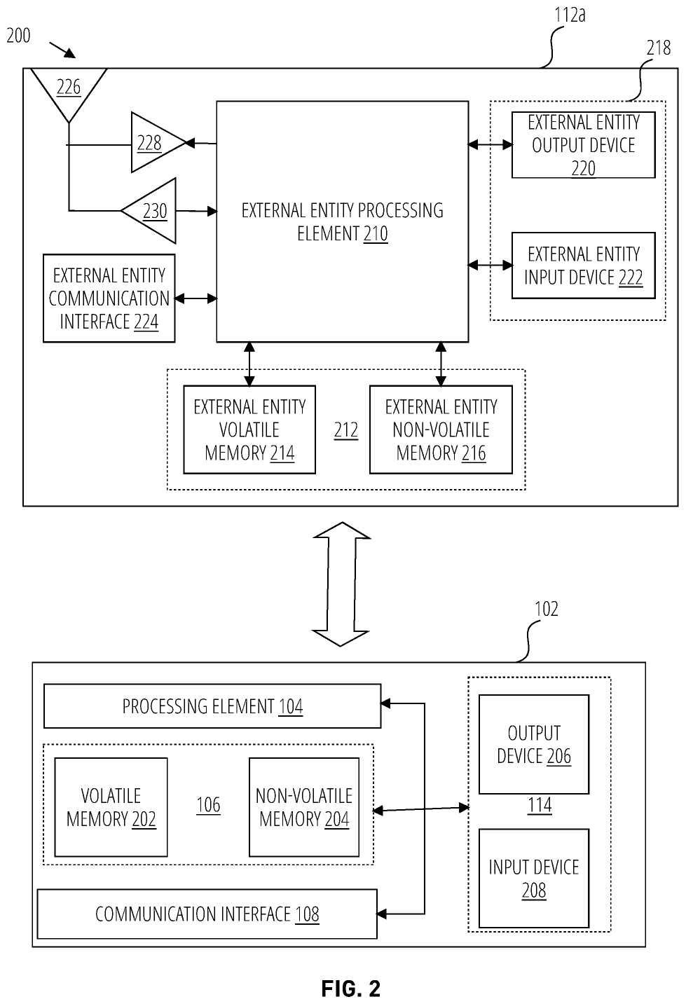

FIG. 2 is a schematic diagram showing a system computing architecture 200 in accordance with some embodiments discussed herein. In some embodiments, the system computing architecture 200 may include the predictive computing entity 102 and/or the external computing entity 112a of the computing system 100. The predictive computing entity 102 and/or the external computing entity 112a may include a computing apparatus, a computing device, and/or any form of computing entity configured to execute instructions stored on a computer-readable storage medium to perform certain steps or operations.

The predictive computing entity 102 may include a processing element 104, a memory element 106, a communication interface 108, and/or one or more I/O elements 114 that communicate within the predictive computing entity 102 via internal communication circuitry, such as a communication bus and/or the like.

The processing element 104 may be embodied as one or more complex programmable logic devices (CPLDs), microprocessors, multi-core processors, coprocessing entities, application-specific instruction-set processors (ASIPs), microcontrollers, and/or controllers. Further, the processing element 104 may be embodied as one or more other processing devices or circuitry including, for example, a processor, one or more processors, various processing devices and/or the like. The term circuitry may refer to an entirely hardware embodiment or a combination of hardware and computer program products. Thus, the processing element 104 may be embodied as integrated circuits, application specific integrated circuits (ASICs), field programmable gate arrays (FPGAs), programmable logic arrays (PLAs), hardware accelerators, digital circuitry, and/or the like.

The memory element 106 may include volatile memory 202 and/or non-volatile memory 204. The memory element 106, for example, may include volatile memory 202 (also referred to as volatile storage media, memory storage, memory circuitry and/or similar terms used herein interchangeably). In one embodiment, a volatile memory 202 may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

The memory element 106 may include non-volatile memory 204 (also referred to as non-volatile storage, memory, memory storage, memory circuitry and/or similar terms used herein interchangeably). In one embodiment, the non-volatile memory 204 may include one or more non-volatile storage or memory media, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

In one embodiment, a non-volatile memory 204 may include a floppy disk, flexible disk, hard disk, solid-state storage (SSS) (e.g., a solid-state drive (SSD)), solid state card (SSC), solid state module (SSM), enterprise flash drive, magnetic tape, or any other non-transitory magnetic medium, and/or the like. A non-volatile memory 204 may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile memory 204 may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

As will be recognized, the non-volatile memory 204 may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

The memory element 106 may include a non-transitory computer-readable storage medium for implementing one or more aspects of the present disclosure including as a computer-implemented method configured to perform one or more steps/operations described herein. For example, the non-transitory computer-readable storage medium may include instructions that when executed by a computer (e.g., processing element 104), cause the computer to perform one or more steps/operations of the present disclosure. For instance, the memory element 106 may store instructions that, when executed by the processing element 104, configure the predictive computing entity 102 to perform one or more step/operations described herein.

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language, such as an assembly language associated with a particular hardware framework and/or operating system platform. A software component comprising assembly language instructions may require conversion into executable machine code by an assembler prior to execution by the hardware framework and/or platform. Another example programming language may be a higher-level programming language that may be portable across multiple frameworks. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together, such as in a particular directory, folder, or library. Software components may be static (e.g., pre-established or fixed) or dynamic (e.g., created or modified at the time of execution).

The predictive computing entity 102 may be embodied by a computer program product include non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media such as the volatile memory 202 and/or the non-volatile memory 204.

The predictive computing entity 102 may include one or more I/O elements 114. The I/O elements 114 may include one or more output devices 206 and/or one or more input devices 208 for providing and/or receiving information with a user, respectively. The output devices 206 may include one or more sensory output devices, such as one or more tactile output devices (e.g., vibration devices such as direct current motors, and/or the like), one or more visual output devices (e.g., liquid crystal displays, and/or the like), one or more audio output devices (e.g., speakers, and/or the like), and/or the like. The input devices 208 may include one or more sensory input devices, such as one or more tactile input devices (e.g., touch sensitive displays, push buttons, and/or the like), one or more audio input devices (e.g., microphones, and/or the like), and/or the like.

In addition, or alternatively, the predictive computing entity 102 may communicate, via a communication interface 108, with one or more external computing entities such as the external computing entity 112a. The communication interface 108 may be compatible with one or more wired and/or wireless communication protocols.

For example, such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In addition, or alternatively, the predictive computing entity 102 may be configured to communicate via wireless external communication using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.9 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

The external computing entity 112a may include an external entity processing element 210, an external entity memory element 212, an external entity communication interface 224, and/or one or more external entity I/O elements 218 that communicate within the external computing entity 112a via internal communication circuitry, such as a communication bus and/or the like.

The external entity processing element 210 may include one or more processing devices, processors, and/or any other device, circuitry, and/or the like described with reference to the processing element 104. The external entity memory element 212 may include one or more memory devices, media, and/or the like described with reference to the memory element 106. The external entity memory element 212, for example, may include at least one external entity volatile memory 214 and/or external entity non-volatile memory 216. The external entity communication interface 224 may include one or more wired and/or wireless communication interfaces as described with reference to communication interface 108.

In some embodiments, the external entity communication interface 224 may be supported by one or more radio circuitry. For instance, the external computing entity 112a may include an antenna 226, a transmitter 228 (e.g., radio), and/or a receiver 230 (e.g., radio).

Signals provided to and received from the transmitter 228 and the receiver 230, correspondingly, may include signaling information/data in accordance with air interface standards of applicable wireless systems. In this regard, the external computing entity 112a may be capable of operating with one or more air interface standards, communication protocols, modulation types, and access types. More particularly, the external computing entity 112a may operate in accordance with any of a number of wireless communication standards and protocols, such as those described above with regard to the predictive computing entity 102.

Via these communication standards and protocols, the external computing entity 112a may communicate with various other entities using means such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The external computing entity 112a may also download changes, add-ons, and updates, for instance, to its firmware, software (e.g., including executable instructions, applications, program modules), operating system, and/or the like.

According to one embodiment, the external computing entity 112a may include location determining embodiments, devices, modules, functionalities, and/or the like. For example, the external computing entity 112a may include outdoor positioning embodiments, such as a location module adapted to acquire, for example, latitude, longitude, altitude, geocode, course, direction, heading, speed, universal time (UTC), date, and/or various other information/data. In one embodiment, the location module may acquire data, such as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating a position of the external computing entity 112a in connection with a variety of other systems, including cellular towers, Wi-Fi access points, and/or the like. Similarly, the external computing entity 112a may include indoor positioning embodiments, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning embodiments may be used in a variety of settings to determine the location of someone or something to within inches or centimeters.

The external entity I/O elements 218 may include one or more external entity output devices 220 and/or one or more external entity input devices 222 that may include one or more sensory devices described herein with reference to the I/O elements 114. In some embodiments, the external entity I/O element 218 may include a user interface (e.g., a display, speaker, and/or the like) and/or a user input interface (e.g., keypad, touch screen, microphone, and/or the like) that may be coupled to the external entity processing element 210.

For example, the user interface may be a user application, browser, and/or similar words used herein interchangeably executing on and/or accessible via the external computing entity 112a to interact with and/or cause the display, announcement, and/or the like of information/data to a user. The user input interface may include any of a number of input devices or interfaces allowing the external computing entity 112a to receive data including, as examples, a keypad (hard or soft), a touch display, voice/speech interfaces, motion interfaces, and/or any other input device. In embodiments including a keypad, the keypad may include (or cause display of) the conventional numeric (0-9) and related keys (#, *, and/or the like), and other keys used for operating the external computing entity 112a and may include a full set of alphabetic keys or set of keys that may be activated to provide a full set of alphanumeric keys. In addition to providing input, the user input interface may be used, for example, to activate or deactivate certain functions, such as screen savers, sleep modes, and/or the like.

### III. Examples of Certain Terms

In some embodiments, the term “multi-task process” refers to a data entity that describes a plurality of related computing tasks for facilitating a complex computing action. The multi-task process may include a series of interdependent related computing tasks that may be performed sequentially to generate a final process result. The multi-task process may include any type of complex, multi-step process with a plurality of interdependent computing tasks. The type of process may be based on a particular use case. As one example, the multi-task process may include an actuarial model for processing claims in a health insurance market. As other examples, the multi-task process may include complex data aggregation, processing, and/or prediction pipelines applied in any of a plurality of other domains.

In some embodiments, the multi-task process is encapsulated in an abstraction that includes a series of interdependent formulae or steps that define functions of various computing tasks. In some examples, the multi-task process may include many thousands of interdependent computing tasks and may incorporate thousands of input parameters. The computing tasks may be executed to process various inputs to generate a process result. The inputs may be provided by a user, a first party, and/or received from external databases or other external services (e.g., via public/private application programming interfaces (“APIs”)). Each of the computing tasks may range in complexity from simple arithmetic calculations to performing highly complex calculations on huge datasets.

In some embodiments, the term “computing task” refers to a data entity that describes a computing function, algorithm, calculation, and/or any other type of computing activity. A computing task may include an individual formula or step of a multi-task process. The computing task may range in complexity from a simple arithmetic calculation to performing complex data aggregation calculations on one or more large datasets. By way of example, a computing task may include an algebraic equation with one or more variables, constants, operators, coefficients, and/or the like. As another example, a computing task may include interface calls (e.g., API calls, service calls, data source calls, etc.) to one or more services, data sources, and/or the like. The interface calls, for example, may be used to access data sources and/or functionality to perform a service. As one example, a service call may be made to access a machine learning model for performing a machine learning analysis.

In some embodiments, the computing task includes dependent variables that may depend on an output of another, prerequisite computing task. By way of example, a first computing task may include variables that may be solved by a second and third computing task, respectively. In such a case, the second and third computing tasks may be prerequisite computing tasks of the first computing task. As described herein, computing tasks may be sequentially executed such that all prerequisite computing tasks for a respective task are executed before the respective task.

In some embodiments, a computing task includes a plurality of task parameters indicative of one or more characteristics of the computing task. The task parameters, for example, may include a task identifier, one or more task services, one or more task arguments, and/or the like. The task identifier may include a unique task code, label, name, and/or other data value for uniquely identifying an individual computing task. The task services may include one or more computing operations of the individual computing task. The computing operations may include primitive local operations, such as simple arithmetic operations. In addition, or alternatively, the computing operations may include calls (e.g., via one or more APIs, and/or the like) to remote services, such as machine learning services and/or the like. The task arguments may include input parameters for performing the task services. The task arguments, for example, may include data values that may be input to a primitive local operation and/or included in one or more calls to remote services. In some examples, the task arguments may be based on one or more prerequisite computing tasks. For instance, the task arguments may be received from and/or output by the prerequisite computing tasks.

A computing task may be associated with one or more attributes based on the task parameters. The attributes, for example, may be indicative of a complexity, timing, processing intensity, and/or the like for a computing task. As one example, the attributes may include a timing attribute representative of an estimated time period for executing the computing task.

In some embodiments, the term “dependency graph” refers to a data structure that defines a plurality of task dependencies of a plurality of related computing tasks of a multi-task process. The dependency graph may include any type of data structure including, as examples, one or more disjoint-set data structures, table data structures, tree data structures, and/or the like. The dependency graph may include a plurality of task data entities representative of the related computing tasks and one or more dependency data entities representative of one or more dependencies between the related computing tasks.

In some embodiments, the dependency graph is a dependency tree that includes a plurality of task nodes linked by one or more dependency links. The dependency tree may include any type of tree data structure including, as an example, a directed acyclic graph (DAG). Each task node of the dependency tree may correspond to a respective computing task of the multi-task process. A dependency link between two task nodes may represent a hierarchical relationship (e.g., parent-child relationship) between two computing tasks in which the output of a first task node (e.g., a parent node for a dependent computing task) is dependent on the output of a second task node (e.g., a child node for a prerequisite computing task). A root node of the dependency tree may represent a final computing task of the multi-task process that may depend on the outputs of a plurality of computing tasks represented by a plurality of leaf nodes of the dependency tree. As described herein, the computing task of a task node may be executed after the execution of each child node depending on the task node. For instance, a child node may represent a dependent task for the computing task of the parent node. To improve processing speeds, computational efficiency, and computing resource utilization, computing tasks of each task node that is not associated with an unexecuted child node may be executed in parallel. In some embodiments, a task node is removed from the dependency tree after its corresponding computing task is executed. In such a case, a task node may be added to an execution queue once all dependent task nodes are removed from the dependency tree.

In some embodiments, the term “processing environment” refers to one or more software modules, hardware components, and/or combinations thereof that are configured to execute instructions for implementing at least a portion (e.g., computing tasks, and/or the like) of a multi-task process. A processing environment, for example, may include one or more physical and/or virtual processing entities and/or one or more portions thereof. A processing environment may include a local processing environment configured to execute each computing task of a multi-task process. In addition, or alternatively, the processing environment may include at least one of a local processing environment and/or a remote processing environment.

In some embodiments, the term “local processing environment” refers to a processing environment configured to execute the multi-task process. The local processing environment may include a virtual processing environment, such as a container, virtual machine, and/or the like. For example, the local processing environment may include a containerized environment configured to instantiate and/or run the multi-task process by executing the computing tasks in accordance with a dependency graph for the multi-task process. The containerized environment may include any type of virtual processing environment including, as examples, one or more certified managed containers, elastic virtual private servers (elastic VPS), custom docker containers, docker engine CE (docker native), Kubernetes containers, and/or the like.

In some embodiments, a local processing environment for a respective multi-task process is configured to execute the computing tasks of the process by leveraging one or more processing and/or memory resources allocated to the local processing environment. By way of example, a local processing environment may be allocated one or more processing units (e.g., central processing units (CPUs), processing cores, and/or the like) and/or segments of computer memory, cloud storage, and/or the like.

In some embodiments, a local processing environment may be associated with one or more static performance attributes based on the processing and/or memory resources allocated to the local processing environment. For example, the static performance attributes may be indicative of a processing and/or storage capability of the local processing environment. The processing and/or storage capability, for example, may define a threshold number of computing tasks that may be performed in parallel by the local processing environment. By way of example, the threshold number of computing tasks may be based on a number of CPUs and/or cores (e.g., a 1 to 1 core to task ratio, and/or the like) allocated to the local processing environment.

In some embodiments, the term “current local state” refers to a data entity that describes one or more parameters of the local processing environment at a current time period. For example, the current local state may represent an instantaneous state of a local processing environment just before a computing task is executed. The current local state for the local processing environment may be indicative of the static performance attributes, such as a processing and/or storage capability of the local processing environment. In addition, or alternatively, the current local state may be indicative of one or more dynamic performance attributes for the local processing environment. The dynamic performance attributes may be indicative of a current processing capability, an available memory, a processing queue state, and/or any other dynamic attribute that may be reflective of the capability of the local processing environment to process a computing task. The current processing capability, for example, may describe an available portion (e.g., one or more unused processing resources and/or memory) of the processing and/or storage capability of the local processing environment. The processing queue state may describe one or more computing tasks currently being processed and/or queued for processing on at the local processing environment.

In some embodiments, the term “remote processing environment” refers to a processing environment remote from the local processing environment. The remote processing environment, for example, may include a remote compute instance that is not configured to execute the multi-task process. The remote processing environment may include a server (e.g., “bare-metal” server), a virtual processing environment (e.g., a container, virtual machine), and/or the like.

In some embodiments, the remote processing environment includes one or more remote instances hosted by a remote platform. For example, the remote platform may include a serverless platform leveraged to automatically configure and instantiate one or more serverless instances in an on-demand setting. The serverless platform may include any type of on-demand serverless technology including, as one example, kNative and/or the like. Using the serverless platform, one or more serverless instances of a remote processing environment may be automatically instantiated to execute one or more computing tasks across one or more different multi-task processes.

Each remote instance of the remote processing environment may be configured to execute at least one computing task by leveraging one or more processing and/or memory resources allocated to the remote instance. By way of example, a remote instance may be allocated one or more processing units (e.g., CPUs, processing cores, and/or the like) and/or portions of computer memory, cloud storage, and/or the like.

The remote processing environment may be associated with one or more static instantiation attributes that describe one or more performance characteristics of the remote processing environment.

As one example, the static instantiation attributes may describe one or more instantiation constraints for the remote processing environment. The instantiation constraints may identify a threshold number of remote instances that may be instantiated over a period of time. The threshold number of remote instances may be based on performance criteria, budgetary constraints, and/or the like.

As another example, the static instantiation attributes may describe one or more processing and/or memory resources available for each of one or more instantiated remote instances. For example, the static instantiation attributes may be indicative of a processing and/or storage capability of each instantiated remote instance. The processing and/or storage capability for a respective instantiated remote instance may define a threshold number of computing tasks that may be performed in parallel by the remote instance. By way of example, the threshold number of computing tasks may be based on the processing units and/or portions of memory allocated to the remote instance.

In some embodiments, the term “current remote state” refers to a data entity that describes one or more parameters of the remote processing environment at a current time period. For example, the current remote state may represent an instantaneous state of a remote processing environment just before a computing task is executed. The current remote state for the remote processing environment may be indicative of the static instantiation attributes for the remote processing environment. In addition, or alternatively, the current remote state may be indicative of one or more dynamic instantiation attributes for the remote processing environment. The dynamic instantiation attributes may be indicative of a current processing capability, an available memory, a processing queue state, and/or any other dynamic attribute that may be reflective of the capability of the remote processing environment to process a computing task. The current processing capability, for example, may describe an available portion (e.g., one or more unused processing resources and/or memory) of the processing and/or storage capability of one or more instantiated remote instances of the remote processing environment. The processing queue state may describe one or more computing tasks currently being processed and/or queued for processing by the instantiated remote instances of the remote processing environment.

In some embodiments, the current remote state is indicative of an instantiation probability that describes the likelihood of instantiating a new remote instance of the remote processing environment for an individual computing task. The instantiation probability, for example, may be based on the static and/or dynamic instantiation attributes. For example, the instantiation probability may increase as the current processing capability and/or available memory for one or more currently instantiated remote instances decreases. In addition, or alternatively, the instantiation probability may increase as the processing queues for the instantiated remote instances approach one or more queuing constraints.

In some embodiments, the term “optimal processing decision” refers to a model output that describes a processing environment for executing an individual computing task of a multi-task process. The optimal processing decision may be indicative of whether to process the individual computing task in a local processing environment and/or a remote processing environment based on a plurality of attributes of the computing task, the local processing environment, and the remote processing environment. In some embodiments, an optimization model is leveraged to generate an optimal processing decision for each respective computing task of a multi-task process to optimally delegate processing activities across a plurality of computing resources.

In some embodiments, the term “optimization model” refers to a data entity that describes parameters, hyper-parameters, and/or defined operations of a rules-based and/or machine learning model (e.g., model including at least one of one or more rule-based layers, one or more layers that depend on trained parameters, coefficients, and/or the like). An optimization model may include a machine learning optimization model that is trained to generate an optimal processing decision for processing one or more individual computing tasks of a multi-task process. The machine learning optimization model may include one or more of any type of machine learning model including one or more supervised, unsupervised, semi-supervised, and/or reinforcement learning models. In some embodiments, the machine learning optimization model may include multiple models configured to perform one or more different stages of an optimization process.

In some embodiments, an optimization model includes a machine learning model trained, using one or more supervised training techniques, to generate an optimal processing decision for an individual computing task based on the computing task as well as the current states of a plurality of local and/or remote environments. The optimization model may include one or more offline machine learning models. For instance, the optimization model may include a supervised machine learning model trained using one or more offline training techniques. By way of example, the optimization model may include one or more classifier models, such as a Support Vector Machine, Naïve Bayes, Logistic Regression, and/or the like. In some embodiments, the classifier model is trained using historical and/or simulated training data. The classifier model may be updated periodically as training data is generated, received, and/or modified.

In some embodiments, an optimization model includes a machine learning model trained, using one or more reinforcement training techniques, to generate an optimal processing decision for an individual computing task based on the computing task as well as the current states of a plurality of local and/or remote environments. The machine learning model may include a reinforcement machine learning model. For example, the machine learning model may include one or more online learning models that may be continually updated in real-time and/or semi-real-time as the machine learning model generates optimal processing decisions.

### IV. Overview, Technical Improvements, and Technical Advantages

Embodiments of the present disclosure present task orchestration techniques that improve resource allocation and load balancing for processing individual or multiple interdependent computing tasks of a multi-task process. To do so, the task orchestration techniques leverage an optimization model to generate an optimal processing decision for each computing task of a multi-task process before the task is executed. The optimization model may be previously configured and/or trained to generate an optimal processing decision that intelligently identifies an optimal computing environment for performing a computing task based on characteristics of the computing task as well as the instantaneous states of available computing environments. In this way, the present disclosure provides improved task orchestration techniques capable of tailoring processing decisions to each individual computing task of a multi-task process.

Traditional task orchestration, or load balancing, techniques attempt to ensure that a processing load is spread evenly across available processing environments (e.g., compute nodes, etc.) by either using simple round robin techniques to distribute computing tasks (e.g., load, etc.) or by examining how busy each processing environment is and then allocating computing tasks to less busy processing environments. In some cases, load balancers may be configured to examine data contained within a computing task to perform load balancing. However, each of these techniques fails to consider the specifics of the computing tasks being run on any given processing environment which may result in overutilized processing environments, underutilized processing environments, and other processing inefficiencies.

In some cases, load balancers may spawn tasks remotely on demand to improve performance. One technique for doing so includes a blunt-force approach where little or no intelligence is used to determine when to run tasks remotely and, like other conventional load balancers, results in sub-optimal use of compute resources and/or financial budgets. Another technique includes employing a set of hard-coded heuristics to determine when to run tasks remotely. However, a good set of heuristics may be unavailable, impractical to implement, and, even if available, may be susceptible to changes over time.

To overcome these deficiencies, the task orchestration techniques of the present disclosure leverage an optimization model that is trained to generate an individualized optimal processing decision for each computing task of a multi-task process. Using the optimization model, a respective computing task may be assigned an optimal processing environment based on the characteristics of the computing task and the instantaneous states of available local and remote computing environments. The optimal processing decision, for example, may identify whether a computing task may be more efficiently processed by a remote processing environment, or locally, by a local processing environment. Each optimal processing decision may be tailored to a respective computing task and the current states of each of the local and remote processing environments at the time the computing task may be executed. Moreover, the optimization model may be periodically trained, or trained on demand, to continually anticipate changing circumstances for multi-task processes and/or associated processing environments.

Example technologically advantageous embodiments of the present disclosure include a generic technique that may be used to solve application specific load balancing problems and an optimization model that: (i) serves as a technology neutral load balancing model, (ii) is adaptable to the specifics of a computing task and the instantaneous state of local and remote environments, and (iii) is transferable to any application with load balancing mechanisms.

### V. Example System Operations

As indicated, various embodiments of the present disclosure make important technical contributions to task orchestration (e.g., load balancing, etc.) techniques. In particular, systems and methods are disclosed herein that implement task orchestration techniques configured to leverage an optimization model to intelligently allocate individual computing tasks of a multi-task process across different disparate processing environments. In this way, the task orchestration techniques improve upon existing load balancing techniques by generating optimal processing decisions tailored to each individual computing task of a multi-task process based on the individual characteristics of the individual computing task and the current states of available processing environments.

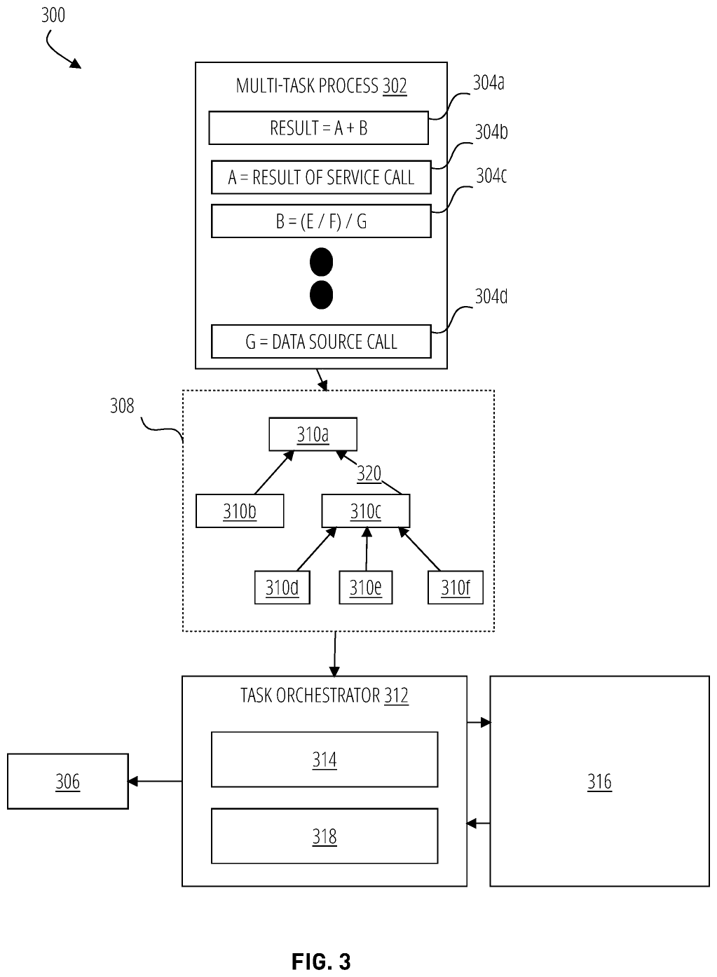

FIG. 3 is a dataflow diagram 300 showing example data structures for intelligently executing a multi-task process in accordance with some embodiments discussed herein. The dataflow diagram 300 depicts a set of data structures and modules for intelligently orchestrating the execution of a multi-task process 302.

In some embodiments, a multi-task process 302 is a data entity that describes a plurality of computing tasks 304a-d for facilitating a complex computing action. The multi-task process may include a series of interdependent computing tasks 304a-d that may be performed sequentially to generate a final process result 306. The multi-task process 302 may include any type of complex, multi-step process with a plurality of computing tasks 304a-d. The type of process may be based on a particular use case. As one example, the multi-task process 302 may include an actuarial model for processing claims in a health insurance market. As other examples, the multi-task process 302 may include complex data aggregation, processing, and/or prediction pipelines applied in any of a plurality of other domains.

In some embodiments, the multi-task process 302 is encapsulated in an abstraction that includes a series of interdependent formulae or steps that define functions of the computing tasks 304a-d. The multi-task process 302 may include a plurality of computing tasks 304a-d including, as examples, a first computing task 304a, a second computing task 304b, a third computing task 304c, a fourth computing task 304d, and/or the like. While four computing tasks 304a-d are illustrated for example purposes, the multi-task process 302 may include many thousands of interdependent computing tasks 304a-d and may incorporate thousands of input parameters. The computing tasks 304a-d may be executed to process various inputs to generate a final process result 306. The inputs may be provided by a user, a first party, and/or received from external databases or other external services (e.g., via public/private APIs, etc.). Each of the computing tasks 304a-d may range in complexity from simple arithmetic calculations to performing highly complex calculations on huge datasets.

In some embodiments, each of the computing tasks 304a-d describe a computing function, algorithm, calculation, and/or any other type of computing activity. The computing tasks 304a-d may include individual formulae or steps of the multi-task process 302. Each of the computing tasks 304a-d may range in complexity from a simple arithmetic calculation to performing complex data aggregation calculations on one or more large datasets. By way of example, the first computing task 304a and the third computing task 304c may include algebraic equations with one or more variables, constants, operators, coefficients, and/or the like. As another example, the second computing task 304b and the fourth computing task 304d may include interface calls (e.g., API calls, service calls, data source calls, etc.) to one or more services, data sources, and/or the like. The interface calls, for example, may be used to access data sources and/or functionality to perform a service. As one example, the second computing task 304b may include a service call to access a machine learning model for performing a machine learning analysis.

One or more of the computing tasks 304a-d may include dependent variables that may depend on an output of another, prerequisite computing task. By way of example, the first computing task 304a may include variables “a” and “b” that may be solved by the second computing task 304b and the third computing task 304c, respectively. In such a case, first computing task 304a may be dependent on the second computing task 304b and the third computing task 304c. As another example, third computing task 304c may include a variable “g” that may be solved by the fourth computing task 304d, making the third computing task 304c dependent on the fourth computing task 304d. As described herein, the computing tasks 304a-d may be sequentially executed such that all prerequisite computing tasks for a dependent computing task on are executed before the dependent computing task.

In some embodiments, the computing tasks 304a-d of the multi-task process 302 are represented by a dependency graph 308. For instance, the dependency graph 308 may be received and/or generated for the multi-task process 302. As one example, a definition of the multi-task process 302 may be received by a computing system, such as the computing system 100. The computing system 100 may process the multi-task process 302 definition to generate the dependency graph 308. In addition, or alternatively, the computing system 100 may receive a dependency graph 308 previously generated for the multi-task process 302. The multi-task process 302 and/or the dependency graph 308 may be received from one or more front end interfaces (e.g., users of a software program, etc.), one or more external entities (e.g., external entities 112a-c, etc.), and/or any other source.

In some embodiments, the dependency graph 308 is a data structure that defines a plurality of task dependencies of a plurality of computing tasks 304a-d of the multi-task process 302. The dependency graph 308 may include any type of data structure including, as examples, one or more disjoint-set data structures, table data structures, tree data structures, and/or the like. The dependency graph 308 may include a plurality of task data entities representative of the computing tasks 304a-d and one or more dependency data entities representative of one or more dependencies between the computing tasks 304a-d.

In some embodiments, the dependency graph 308 is a dependency tree that includes a plurality of task nodes 310a-f linked by one or more dependency links (e.g., dependency link 320, etc.). For instance, the dependency graph 308 may include a dependency tree with a plurality of task nodes 310a-f corresponding to the computing tasks 304a-d of the multi-task process 302. A first task node 310a, for example, may correspond to the first computing task 304a, the second task node 310b may correspond to the second computing task 304b, the third task node 310c may correspond to the third computing task 304c, the fourth task node 310f may correspond to the fourth computing task 304d, and/or the like.

The dependency tree may include any type of tree data structure, such as a directed acyclic graph (DAG). A dependency link between two task nodes may represent a hierarchical relationship (e.g., parent-child relationship, etc.) between two computing tasks in which the output of a first task node (e.g., a parent node, etc.) may be dependent on the output of a second task node (e.g., a child node, etc.). By way of example, the dependency link 320 may represent a hierarchical relationship between the first computing task 304a and the third computing task 304c and may identify the third computing task 304c as a prerequisite computing task of the first computing task 304a.

The root node (e.g., first task node 310a) of the dependency tree may represent a final computing task (e.g., first computing task 304a) of the multi-task process 302 that may depend on the outputs of a plurality of computing tasks (e.g., computing tasks 304b-d) represented by a plurality of leaf nodes (e.g., task nodes 310b-f) of the dependency tree. As described herein, the computing task of a task node may be executed after the execution of each prerequisite node for the task node. For instance, a prerequisite node may represent a prerequisite task for the computing task of the parent node. To improve processing speeds, computational efficiency, and computing resource utilization, computing tasks of each task node that is not associated with an unexecuted child node may be executed in parallel. In some embodiments, a task node is removed from the dependency tree after its corresponding computing task is executed. In such a case, a task node may be added to a task schedule once all prerequisite task nodes for the task node are removed from the dependency tree. In some examples, one or more terminal task nodes in a current dependency tree may be executed in serial.

In some embodiments, the computing tasks 304a-d of the dependency graph 308 are intelligently processed using a task orchestrator 312. For example, the computing tasks 304a-d may be executed at least partially in parallel based on their dependencies. The task orchestrator 312 may include a computing entity, algorithm, and/or the like that may be configured to identify a computing task 314 of the multi-task process 302 for execution based on the dependency graph 308, facilitate the execution of the computing task 314, and subsequently update the dependency graph 308. By way of example, the task orchestrator 312 may include one or more computing entities of the computing system 100.

In some embodiments, the task orchestrator 312 generates the dependency graph 308 for the multi-task process 302. In addition, or alternatively, the task orchestrator 312 receives and/or accesses a dependency graph 308 that is previously generated for the multi-task process 302.

In some embodiments, the task orchestrator 312 identifies a computing task 314 that is available for execution based on the current graph state of the dependency graph 308. For example, the current graph state of the dependency graph 308 may be indicative of one or more unexecuted computing tasks of the dependency graph 308, one or more executed computing tasks of the dependency graph 308, and/or the like. As one example, the current graph state of the dependency graph 308 may be a current dependency tree including current task nodes representing each of one or more unexecuted computing tasks of the dependency graph 308. The computing task 314 may correspond to an unexecuted, independent, task node of the dependency graph 308 that is unexecuted and is not associated with prerequisite task nodes.

In some embodiments, the task orchestrator 312 continually monitors the dependency graph 308 (e.g., task nodes of a dependency tree, etc.) to identify computing tasks that do not have dependencies (e.g., terminal nodes in dependency tree). The independent computing tasks may be added to an asynchronous task schedule (e.g., queue, stack, etc.). As the independent computing tasks are added to the task schedule, the tasks may be continuously executed in parallel on one or more processing environments 316. The amount of parallelism may be a function of the processing resources (e.g., cores/CPUs, etc.) available to the processing environments 316 such that the number of computing tasks that may be performed concurrently may be constrained by the available processing resources at a respective processing environment. As the computing tasks are executed, they may be removed from the task schedule and, in some examples, removed from the dependency graph 308. This cycle may be repeated until a final computing task of the multi-task process 302 (e.g., corresponding to a root node of a dependency tree) is executed, and the final process result 306 is generated and output (e.g., to a user, a calling application, etc.).

In some embodiments, the computing task 314 is selectively allocated to a type of the processing environments 316 based on one or more parameters of the computing task 314. For example, the computing task 314 may include a plurality of task parameters indicative of one or more characteristics of the computing task 314. The task parameters, for example, may include a task identifier, one or more task services, one or more task arguments, and/or the like. The task identifier may include a unique task code, label, name, and/or other data value for uniquely identifying the computing task 314.

In some embodiments, the task services include one or more computing operations of the computing task. The computing operations may include primitive local operations, such as simple arithmetic operations. In addition, or alternatively, the computing operations may include calls (e.g., via one or more APIs, etc.) to remote services, such as machine learning services and/or the like. By way of example, the computing task 314 may be one or more of a plurality of task types including, as examples, (i) a long running computing task type with one or more task services such as service calls for reading data from an external database, reading large files, using external APIs, invoking external long-running batch processes, and/or the like, (ii) a table reading computing task type with one or more task services for large reads of data tables, and/or the like, (iii) a simple calculation computing task type with one or more task services for performing simple calculations on scalar values, and/or the like, and/or (iv) a complex calculation computing task type with one or more task services for performing complex calculations, and/or the like.

In some embodiments, the task arguments include input parameters for performing the task services. The task arguments, for example, may include data values that may be input to a primitive local operation and/or included in one or more calls to remote services. In some examples, the task arguments may be based on one or more prerequisite computing tasks. For instance, the task arguments may be received from and/or output by the prerequisite computing tasks.

In some embodiments, the computing task 314 is associated with one or more attributes based on the task parameters. The attributes, for example, may be indicative of a complexity, timing, processing intensity, and/or the like for the computing task 314. As one example, the attributes may include a timing attribute representative of an estimated time period for executing the computing task 314.

In some embodiments, the task orchestrator 312 identifies a current graph state for the dependency graph 308 and/or one or more task dependencies for the dependency graph 308 and identifies the computing task 314 based on the current graph state and the task dependencies. The current graph state, for example, may describe one or more executed task nodes, unexecuted task nodes, and/or one or more dependencies thereof of the dependency graph 308 at a current time. For example, an executed task node may describe a task node corresponding to a previously executed computing task of the multi-task process 302. An unexecuted task node may describe a task node corresponding to an unexecuted computing task of the multi-task process 302. In some embodiments, executed task nodes are removed from the dependency graph 308 such that the current graph state may describe each of the remaining task nodes (e.g., unremoved) of the dependency graph 308 at a current time.

The task orchestrator 312 may identify the computing task 314 based on the current graph state and the task dependencies. Once identified, the task orchestrator 312 may allocate the computing task 314 to at least one type of the processing environments 316 based on the task attributes, and/or any other factors described herein.

In some embodiments, the processing environments 316 include one or more software modules, hardware components, and/or combinations thereof that are configured to execute instructions for implementing at least a portion (e.g., computing tasks 304a-d, and/or the like) of the multi-task process 302. A processing environment, for example, may include one or more physical and/or virtual processing entities and/or one or more portions thereof. A processing environment may include a local processing environment configured to execute each of the computing tasks 304a-d of the multi-task process 302. In addition, or alternatively, the processing environments 316 may include at least one of the local processing environments and/or the remote processing environments. For example, a first type of the processing environments 316 may be a local processing environment and a second type of the processing environments 316 may be a remote processing environment.

In some embodiments, the task orchestrator 312 leverages an optimization model 318 to intelligently allocate the computing task 314 to at least one type of the processing environments 316 in accordance with one or more multi-task process orchestration schemes. As described herein, a load balancer may be configured to allocate the computing tasks 304a-d to be performed in serial by a local processing environment. This may lead to processing inefficiencies, long processing times, and degraded resource allocation of the processing environments 316. In order to address these technical problems, the task orchestrator 312 may be used to individually allocate the computing task 314 to an optimal processing environment of the processing environments 316. For instance, using the techniques described herein, each of the computing tasks 304a-d may be individually processed and allocated to one of the processing environments 316 to improve the overall execution performance of the multi-task process 302. To do so, the task orchestrator 312 may generate, using the optimization model 318, an optimal processing decision for the computing task 314. The optimal processing decision may be indicative of a local processing environment and/or a remote processing environment of the processing environments 316. In this way, the optimization model 318 may be used to intelligently and automatically allocate the computing tasks 304a-d between different processing environments 316.

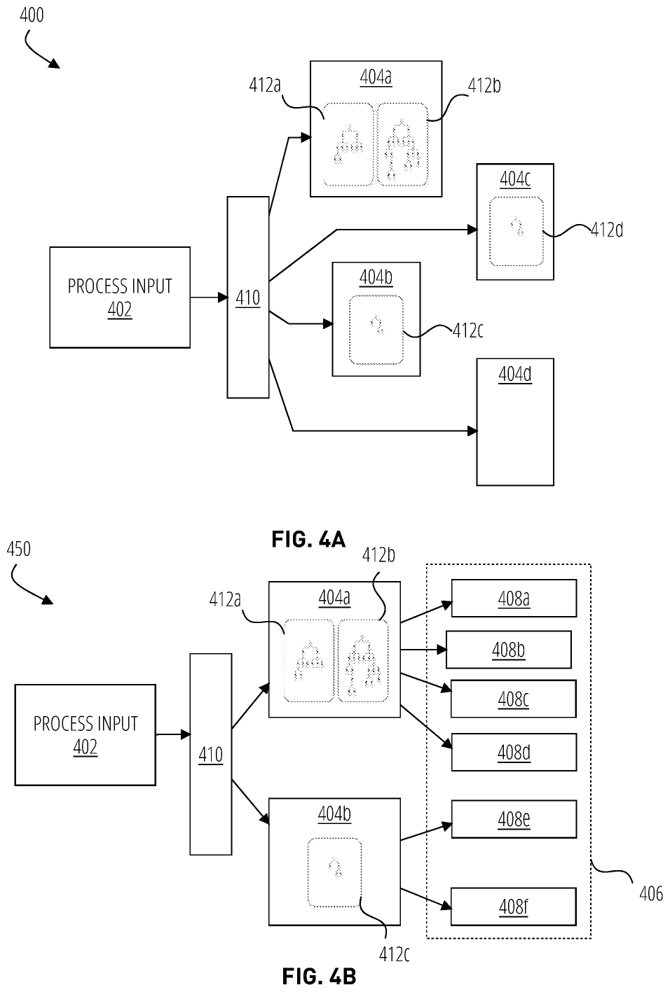

Operational examples of multi-task process orchestration schemes will now further be described with reference to FIGS. 4A-B.

FIG. 4A is an operational example 400 of a multi-task process orchestration scheme leveraging local processing environments in accordance with some embodiments discussed herein. The operational example 400 shows an orchestration scheme in which multi-task processes are allocated among a plurality of local processing environments 404a-d. For example, a load balancer 410 may receive a process input 402. The process input 402 may include at least one of a multi-task process and/or a dependency graph corresponding to the multi-task process. In response to receiving the process input 402, the load balancer 410 may assign the multi-task process to a local processing environment. For example, a first local processing environment 404a may be assigned (e.g., configured, instantiated, etc.) to execute a first dependency graph 412a and a second dependency graph 412b, a second local processing environment 404b may be assigned to execute a third dependency graph 412c, a third local processing environment 404c may be assigned to execute a fourth dependency graph 412d, a fourth local processing environment 404d may be unassigned, and/or the like.

In some embodiments, a local processing environment is a processing environment configured to execute a multi-task process. The local processing environment may include a virtual processing environment, such as a container, virtual machine, and/or the like. For example, the local processing environment may include a containerized environment configured to instantiate and/or run the multi-task process by executing the computing tasks in accordance with a dependency graph for the multi-task process. The containerized environment may include any type of virtual processing environment including, as examples, one or more certified managed containers, elastic virtual private servers (elastic VPS), custom docker containers, docker engine CE (docker native), Kubernetes containers, and/or the like.

In some embodiments, a local processing environment for a respective multi-task process is configured to execute the computing tasks of the process by leveraging one or more processing and/or memory resources allocated to the local processing environment. By way of example, a local processing environment may be allocated one or more processing units (e.g., CPUs, processing cores, and/or the like) and/or segments of computer memory, cloud storage, and/or the like.

In some embodiments, a local processing environment is associated with one or more static performance attributes based on the processing and/or memory resources allocated to the local processing environment. For example, the static performance attributes may be indicative of a processing and/or storage capability of the local processing environment. The processing and/or storage capability, for example, may define a threshold number of computing tasks that may be performed in parallel by the local processing environment. By way of example, the threshold number of computing tasks may be based on a number of CPUs and/or cores (e.g., a 1 to 1 core to task ratio, and/or the like) allocated to the local processing environment.

In the operational example 400, the dependency graphs 412a-d are each scaled out in their respective entireties across the local processing environments 404a-d. In such a case, some processing environments, such as the first local processing environment 404a, may be overutilized if assigned one or more large, long-running multi-task processes, while potentially other local processing environments, such as the fourth local processing environment 404d, remain idle. Overutilized processing environments may lead to processing inefficiencies as each processing environment may be constrained by its allocated processing and/or memory resources. To overcome these processing inefficiencies and maximize the amount of work that may be performed in parallel, underutilized processing environments may be used, as remote processing environments, to execute individual computing tasks from multi-task processes assigned to overutilized processing environments. In this way, remote processing environments may be used to augment the processing and/or storage capabilities of overutilized local processing environments.

FIG. 4B is an operational example 450 of a multi-task process orchestration scheme leveraging local and remote processing environments in accordance with some embodiments discussed herein. The operational example 450 shows an orchestration scheme in which multi-task processes are allocated among a plurality of local processing environments 404a-b. For example, a load balancer 410 may receive a process input 402. The process input 402 may include at least one of a multi-task process and/or a dependency graph corresponding to the multi-task process. In response to receiving the process input 402, the load balancer 410 may assign the multi-task process to a local processing environment. For example, a first local processing environment 404a may be assigned (e.g., configured, instantiated, etc.) to execute a first dependency graph 412a and a second dependency graph 412b, a second local processing environment 404b may be assigned to execute a third dependency graph 412c, and/or the like. In addition to the local processing environments 404a-b, a remote processing environment 406 may be leveraged to improve processing efficiencies for the process input 402.

In some embodiments, the remote processing environment 406 is a processing environment remote from the local processing environments 404a-b. The remote processing environment 406, for example, may include a remote compute instance that is not configured to execute the multi-task process. The remote processing environment 406 may include a server (e.g., “bare-metal” server), virtual processing environment (e.g., a container, virtual machine), and/or the like.

In some embodiments, the remote processing environment 406 includes one or more remote instances 408a-f hosted by a remote platform. For example, the remote platform may include a serverless platform leveraged to automatically configure and instantiate one or more serverless instances in an on-demand setting. The serverless platform may include any type of on-demand serverless technology including, as one example, kNative and/or the like. Using the serverless platform, one or more serverless instances of the remote processing environment 406 may be automatically instantiated to execute one or more computing tasks across one or more different multi-task processes.

Each remote instance 408a-f of the remote processing environment 406 may be configured to execute at least one computing task by leveraging one or more processing and/or memory resources allocated to the remote instance. By way of example, a remote instance may be allocated one or more processing units (e.g., CPUs, processing cores, and/or the like) and/or portions of computer memory, cloud storage, and/or the like.

The remote processing environment 406 may be associated with one or more static instantiation attributes that describe one or more performance characteristics of the remote processing environment 406. As one example, the static instantiation attributes may describe one or more instantiation constraints for the remote processing environment 406. The instantiation constraints may identify a threshold number of the remote instances 408a-f that may be instantiated, utilized, and/or the like over a period of time. The threshold number of the remote instances 408a-f may be based on performance criteria, budgetary constraints, and/or the like. As another example, the static instantiation attributes may describe one or more processing and/or memory resources available for each of the remote instances 408a-f. For example, the static instantiation attributes may be indicative of a processing and/or storage capability of each of the remote instances 408a-f. The processing and/or storage capability for a remote instance may define a threshold number of computing tasks that may be performed in parallel by the remote instance. By way of example, the threshold number of computing tasks may be based on the processing units and/or portions of memory allocated to the remote instance.

In some embodiments, the remote instances 408a-f are automatically configured (e.g., instantiated, etc.) to execute individual computing tasks of a multi-task process, on demand, outside of a local processing environment assigned to perform the multi-task process. In some examples, a naive algorithm may be applied to spawn a new remote instance for each computing task of a multi-task process. However, this may lead to a worse performance due to the time and processing expenditure for configuring (e.g., instantiating, etc.) a series of remote instances 408a-f. For instance, the time and processing resources expended to configure a new remote instance for each computing task of a multi-task process may outweigh the potential performance gains that would be achieved through locally parallelizing the computing tasks within a local processing environment. Moreover, in some examples, a computing task may receive input parameters (e.g., for task arguments, etc.) and output results that are serialized and transported across a network between a local processing environment and the remote processing environment 406. If overused, transmission times between each environment may reduce or eliminate any potential efficiency gains achieved through the use of the remote processing environment 406.

To intelligently augment the capabilities of the local processing environments 404a-b with those provided by the remote processing environment 406, a task allocation scheme may be implemented that intelligently judges which computing tasks are best executed by the local processing environments 404a-b and which are best executed in the remote processing environment 406.

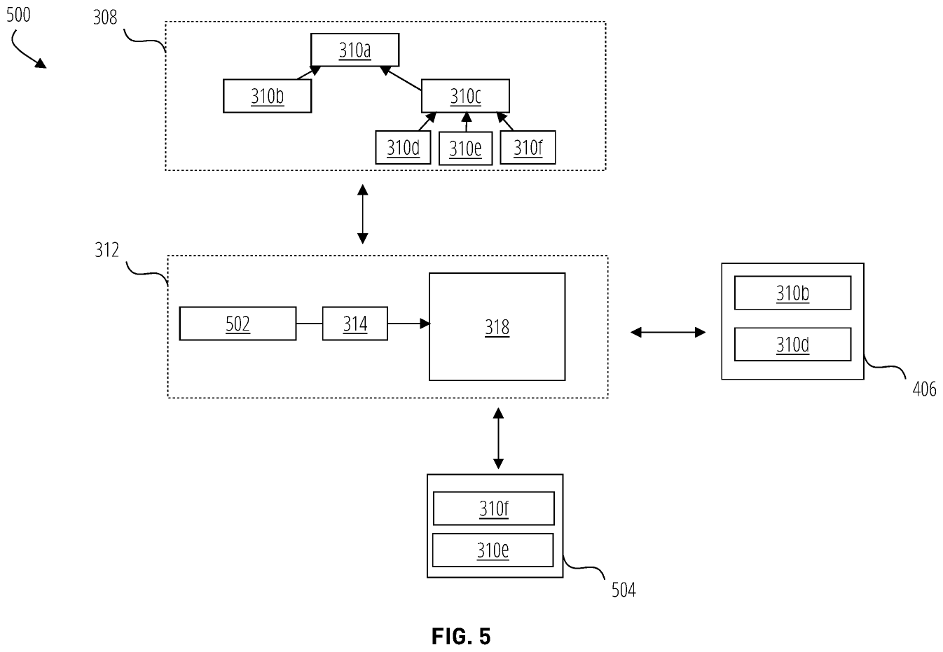

An example task allocation scheme leveraging local and remote processing environments will now further be described with reference to FIG. 5.

FIG. 5 is an operational example 500 of a task allocation scheme in accordance with some embodiments discussed herein. The operational example 500 includes a task orchestrator 312 configured to process and allocate computing tasks corresponding to each of the task nodes 310a-f of a dependency graph 308 for a multi-task process. In some examples, the task orchestrator 312 may be configured to flatten the dependency graph 308 by adding one or more independent computing tasks (e.g., computing tasks with no unexecuted prerequisite tasks, computing tasks corresponding to terminal nodes of the dependency graph, etc.) to a task schedule 502. The task schedule 502 may include any type of organizational data structure, such as a queue, a stack, and/or the like. As one example, the task schedule 502 may include a priority queue. Each computing task of the task schedule 502 may be processed by the optimization model 318 in a sequential manner (e.g., first in first out (“FIFO”), last in first out (“LIFO”), etc.).

In some embodiments, the task orchestrator 312 leverages the optimization model 318 to generate an optimal processing decision for each computing task of the multi-task process. For example, the computing task 314 may be identified from the dependency graph 308 and/or task schedule 502 and processed to optimally allocate the computing task 314 to a processing environment. The optimal processing decision may identify a processing environment for executing each of the individual computing tasks of a multi-task process. In this way, the optimization model 318 may be used to intelligently distribute the computing tasks of a multi-task process across both the local processing environment 504 for the multi-task process and the remote processing environment 406 remote from the local processing environment 504. By way of example, optimal processing decisions for a first set of computing tasks (e.g., tasks corresponding to the task nodes 310e-f) may identify the local processing environment 504 for executing the computing tasks. As another example, optimal processing decisions for a second set of computing tasks (e.g., tasks corresponding to task nodes 310b and 310d) may identify the remote processing environment 406 for executing the computing tasks.

In some embodiments, in response to an optimal processing decision identifying the local processing environment 504 for the computing task 314, the task orchestrator 312 assigns the computing task 314 to a local processing queue of the local processing environment 504. The local processing environment 504 may be configured to execute the computing task 314 in serial with one or more other computing tasks of the local processing queue.

In some embodiments, in response to an optimal processing decision identifying the remote processing environment 406 for the computing task 314, the task orchestrator 312 assigns the computing task 314 to a remote processing queue of the remote processing environment 406. In some examples, the allocation of the computing task to the remote processing environment 406 may initiate the configuration (e.g., instantiating, etc.) of a new remote instance of the remote processing environment 406. In such a case, the computing task 314 may be assigned to a remote processing queue of the new remote instance. In addition, or alternatively, the computing task 314 may be assigned to a remote processing queue of an existing remote instance. The remote processing environment 406 (e.g., one or more remote instances thereof) may be configured to execute the computing task 314 in serial with one or more other computing tasks of a respective remote processing queue.

In some embodiments, the optimal processing decision includes a model output that describes a processing environment for executing the computing task 314 of a multi-task process. The optimal processing decision may be indicative of whether to process the computing task 314 in the local processing environment 504 and/or the remote processing environment 406 based on a plurality of attributes of the computing task 314, the local processing environment 504, and/or the remote processing environment 406. In some embodiments, the optimization model 318 is leveraged to generate an optimal processing decision for each respective computing task of a multi-task process to optimally delegate processing activities across a plurality of disparate computing resources.

In some embodiments, the optimization model 318 is a data entity that describes parameters, hyper-parameters, and/or defined operations of a rules-based and/or machine learning model (e.g., model including at least one of one or more rule-based layers, one or more layers that depend on trained parameters, coefficients, and/or the like). The optimization model 318 may include a machine learning optimization model that is trained to generate an optimal processing decision for processing one or more individual computing tasks of a multi-task process. The machine learning optimization model may include one or more of any type of machine learning model including one or more supervised, unsupervised, semi-supervised, and/or reinforcement learning models. In some embodiments, the machine learning optimization model may include multiple models configured to perform one or more different stages of an optimization process.

In some embodiments, the optimization model 318 includes a machine learning model trained, using one or more supervised training techniques, to generate an optimal processing decision for the computing task 314 based on the computing task as well as the current states of a plurality of local processing environment 504 and/or remote processing environment 406. By way of example, the task orchestrator 312 may receive a current local state for the local processing environment 504 and/or a current remote state for the remote processing environment 406.

In some embodiments, the current local state describes one or more parameters of the local processing environment 504 at a current time period. For example, the current local state may represent an instantaneous state of the local processing environment 504 just before the computing task 314 is scheduled to be executed. The current local state for the local processing environment 504 may be indicative of the static performance attributes, such as a processing and/or storage capability of the local processing environment 504. In addition, or alternatively, the current local state may be indicative of one or more dynamic performance attributes for the local processing environment 504. The dynamic performance attributes may be indicative of a current processing capability, an available memory, a processing queue state, and/or any other dynamic attribute that may be reflective of the capability of the local processing environment's 504 ability to process the computing task 314. The current processing capability, for example, may describe an available portion (e.g., one or more unused processing resources and/or memory) of the processing and/or storage capability of the local processing environment 504. The processing queue state may describe one or more computing tasks (e.g., for task nodes 310e-f) currently being processed and/or queued for processing at the local processing environment 504. In some embodiments, the processing queue state describes the task parameters of the computing tasks.

In some embodiments, the current remote state describes one or more parameters of the remote processing environment 406 at a current time period. For example, the current remote state may represent an instantaneous state of a remote processing environment just before the computing task 314 is scheduled to be executed. The current remote state for the remote processing environment 406 may be indicative of the static instantiation attributes for the remote processing environment 406. In addition, or alternatively, the current remote state may be indicative of one or more dynamic instantiation attributes for the remote processing environment 406. The dynamic instantiation attributes may be indicative of a current processing capability, an available memory, a processing queue state, and/or any other dynamic attribute that may be reflective of the capability of the remote processing environment 406 to process the computing task 314. The current processing capability, for example, may describe an available portion (e.g., one or more unused processing resources and/or memory) of the processing and/or storage capability of one or more instantiated remote instances of the remote processing environment 406. The processing queue state may describe one or more computing tasks (e.g., for task nodes 310b and 310d) currently being processed and/or queued for processing by the instantiated remote instances of the remote processing environment 406. In some embodiments, the processing queue state describes the task parameters of the computing tasks.

In some embodiments, the current remote state is indicative of an instantiation probability that describes a likelihood of instantiating a new remote instance of the remote processing environment 406 for the computing task 314. The instantiation probability, for example, may be based on the static and/or dynamic instantiation attributes. For example, the instantiation probability may increase as the current processing capability and/or available memory for one or more currently instantiated remote instances decreases. In addition, or alternatively, the instantiation probability may increase as the processing queues for the instantiated remote instances approach one or more queuing constraints.

In some embodiments, the task orchestrator 312 provides task-specific input data to the optimization model 318 and receives, in response to the input data, the optimal processing decision for the computing task 314. The input data may be task-specific and may vary for each computing task of the multi-task process. For example, the input data for the computing task 314 may include the task parameters and/or attributes for the computing task 314. In addition, or alternately, the input data may include a current local state for the local processing environment 504 and/or a current remote state for the remote processing environment 406, each corresponding to a time at which the computing task 314 may be executed.

In some embodiments, the task orchestrator 312 generates the input data for the computing task 314. The input data may be generated from an internal representation and/or through one or more communication channels with the local processing environment 504 and/or the remote processing environment 406. For example, the task orchestrator 312 may receive the current local state (e.g., a snapshot, etc.) from the local processing environment 504 at a current time. As another example, the task orchestrator 312 may receive the current remote state (e.g., a snapshot, etc.) from the remote processing environment 406 at the current time. In addition, or alternatively, the task orchestrator 312 may monitor the remote/local states of the local processing environment 504 and/or the remote processing environment 406. For example, the task orchestrator 312 may dynamically update an internal representation (e.g., data structure, model, etc.) indicative of the current local/remote states of the local processing environment 504 and the remote processing environment 406. The task orchestrator 312 may continuously update the internal representation as computing tasks are assigned to each environment to maintain an accurate representation of the current local state and the current remote state.

The optimization model 318 may be trained (and/or otherwise configured) to output an optimal processing decision for the computing task 314 based on the input data for the computing task 314. As examples, the input data may be indicative of one or more of the following: (i) a number of processing resources (e.g., cores, CPUs, etc.) available on the local processing environment 504, (ii) length of computing tasks (e.g., local processing queue) already scheduled to run in the local processing environment 504, (iii) a type (e.g., long running computing task type, table reading computing task type, simple calculation computing task type, complex calculation computing task type, etc.), mix, and/or other characteristics (e.g., attributes, task parameters, etc.) of computing tasks in the local processing queue, (iv) the type of data returned (e.g., single values, large lists of values, rows of data from an external database, etc.) by the computing task 314, (v) a number of processing resources (e.g., cores, CPUs, etc.) available on the remote processing environment 406, (vi) length of computing tasks (e.g., remote processing queue) already scheduled to run in the remote processing environment 406, (vii) a type, mix, and/or other characteristics of computing tasks in the remote processing queue, (viii) an instantiation probability for the remote processing environment 406, (ix) a current number of instantiated remote instances of the remote processing environment 406, (x) instantiation constraints (e.g., a maximum number of remote instances, etc.) for the remote processing environment 406, (xi) historical optimal processing decisions for the computing task 314 (e.g., whether the computing task 314 has previously been executed by the local processing environment 504 and/or remote processing environment 406), (xii) a complexity and/or estimated execution time/duration for the computing task 314, and/or any other factors associated with the execution of the computing task 314 at either the local processing environment 504 and/or remote processing environment 406. The factors listed above are provided for example purposes and are not to be construed as a closed list. The input data for a respective computing task may include any of the above factors and/or any other factors not explicitly listed.

In some embodiments, the optimization model 318 includes a supervised machine learning model. For example, the machine learning model may include one or more classifier models. The classifier models, for example, may include a Support Vector Machine, Naïve Bayes, Logistic Regression, and/or the like. In some embodiments, the classifier models are trained using historical and/or simulated training data (e.g., training/simulated computing tasks, current local states, current remote states, etc.). The classifier model may be updated periodically as training data is generated, received, and/or modified.

In some embodiments, the optimization model 318 includes a machine learning model trained, using one or more reinforcement training techniques, to generate the optimal processing decision for the computing task 314 based on the computing task 314 as well as the current states of a local processing environment 504 and the remote processing environment 406. The machine learning model may include a reinforcement machine learning model. For example, the machine learning model may include one or more offline and/or online machine learning models that may be continually updated in real-time and/or semi-real-time as the machine learning model generates optimal processing decisions.

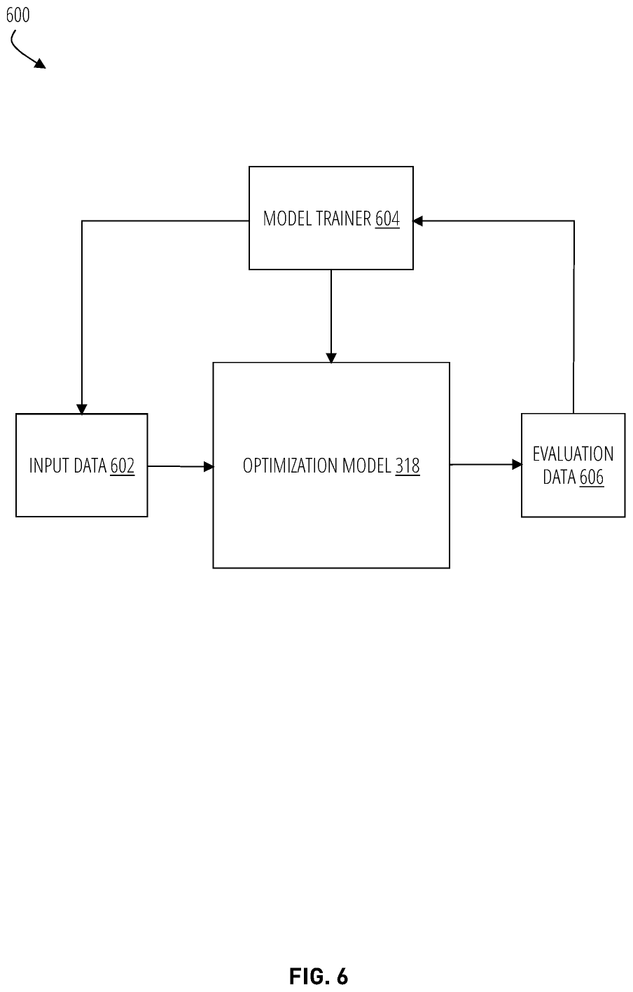

An example training scheme for training the optimization model 318 will now further be described with reference to FIG. 6.

FIG. 6 is an operational example 600 showing example training techniques for training the optimization model in accordance with some embodiments discussed herein. The optimization model 318 may be trained in real-time and/or periodically by a model trainer 604. The model trainer 604 may include a computing entity, algorithm, and/or the like that may be configured to receive and/or generate training input data 602 for the optimization model 318, receive an evaluation data 606 from the optimization model 318, and/or update one or more model parameters of the optimization model 318 based on the evaluation data 606. By way of example, the model trainer 604 may include one or more computing entities of the computing system 100.

The model trainer 604 may generate, receive, and/or otherwise facilitate the input of the input data 602 to the optimization model 318. The input data 602 may include real-time input data for a computing task (e.g., for training online machine learning models, etc.) and/or historical and/or simulation input data for a historical and/or simulated computing task (e.g., for supervised machine learning models, etc.). For example, the model trainer 604 may train the optimization model 318 according to one or more online learning approaches based on the real-time input data. As another example, the model trainer 604 may train the optimization model 318 according to one or more offline learning approaches based on the historical and/or simulation input data.

In an offline learning approach, the model trainer 604 may receive/generate historical input data and/or simulated input data for the optimization model 318. The input data may include (i) pre-defined multi-task processes and/or corresponding dependency graphs, (ii) contextual data for the processes/graphs (e.g., current local states, current remote states, etc.), and/or the like. The historical input data may include historical multi-task processes and/or corresponding dependency graphs. The simulated input data may include simulated multi-task processes and/or corresponding dependency graphs. A simulated multi-task process and/or corresponding dependency graph, for example, may be manually generated and/or automatically generated based on the historical input data. In some embodiments, the simulated input data is generated using a hybrid simulation approach in which the simulated multi-task process and/or corresponding dependency graph is automatically generated based on user inputs indicative of a profile/mix of computing tasks.

In an online learning approach, the model trainer 604 may receive/generate real-time input data including (i) real-time multi-task processes and/or corresponding dependency graphs, (ii) contextual data for the processes/graphs (e.g., current local states, current remote states, etc.), and/or the like. The real-time input data may be received during and/or subsequent to an execution of a real-time multi-task process.

In some embodiments, the input data 602 is divided into training, validation, and testing data sets. At a first training operation, a threshold number of remote instances may be determined (e.g., at random and then refined, etc.) and/or received for a remote processing environment. At a second operation, static performance attributes (e.g., local processing resources, etc.) and/or static instantiation attributes (e.g., remote processing resources, etc.) may be determined (e.g., at random and then refined, etc.) and/or received for a local and/or remote processing environment. At a third operation, the computing tasks of the input data 602 (e.g., a real-time, simulated, and/or historical multi-task process and/or corresponding dependency graph) may be allocated (e.g., at random and then refined, etc.) to either a remote processing environment and/or a local processing environment. At a fourth operation, evaluation data 606 for the optimization model 318 may be received and/or refined. The optimization model 318 may be updated to optimize processing metrics (e.g., overall compute time, compute cost, overused/underutilized compute node, etc.) based on evaluation data 606 received over a plurality of training iterations (and/or in real-time iterations) and evaluating a plurality of different multi-task processes.

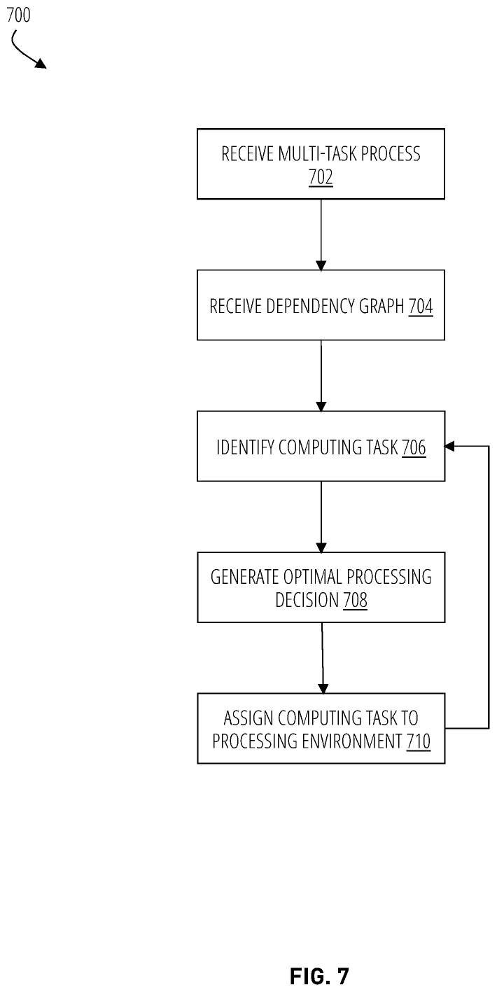

FIG. 7 is a flowchart showing an example of a process 700 for intelligently executing a computing task in accordance with some embodiments discussed herein. The flowchart depicts a first stage of a task processing orchestration technique that overcomes various limitations, such as processing inefficiencies, that are associated with traditional process orchestration techniques. The first stage of the task processing orchestration technique may be implemented by one or more computing devices, entities, and/or systems described herein. For example, via the various steps/operations of the process 700, the computing system 100 may leverage an optimization model to overcome the various limitations with conventional process orchestration techniques that underutilize, overload, and/or otherwise inefficiently use multiple disparate computing resources.

FIG. 7 illustrates an example process 700 for explanatory purposes. Although the example process 700 depicts a particular sequence of steps/operations, the sequence may be altered without departing from the scope of the present disclosure. For example, some of the steps/operations depicted may be performed in parallel or in a different sequence that does not materially impact the function of the process 700. In other examples, different components of an example device or system that implements the process 700 may perform functions at substantially the same time or in a specific sequence.

In some embodiments, the process 700 includes, at step/operation 702, receiving a multi-task process. For example, the computing system 100 may receive the multi-task process. The multi-task process may include a plurality of interdependent computing tasks as described herein. Each computing task of the multi-task process may include a task identifier, one or more task services, and/or one or more task arguments.

In some embodiments, the process 700 includes, at step/operation 704, receiving a dependency graph for the multi-task process. For example, the computing system 100 may receive the dependency graph for the multi-task process. As one example, the dependency graph may include a plurality of task nodes corresponding to the computing tasks of the multi-task process.

In some embodiments, the process 700 includes, at step/operation 706, identifying a computing task from the multi-task process. For example, the computing system 100 may identify the computing task from the multi-task process based on the dependency graph. The computing task, for example, may be identified from a task node of the dependency graph. In some embodiments, a task schedule is generated based on the dependency graph. In such a case, the computing task may be identified from the task schedule.

In some embodiments, the computing system 100 identifies a current graph state and one or more task dependencies for the dependency graph. The computing system 100 may identify an individual computing task of the multi-task process based on the current graph state and/or the task dependencies of the dependency graph.

In some embodiments, the process 700 includes, at step/operation 708, generating an optimal processing decision for the computing task. For example, the computing system 100 may generate the optimal processing decision for the computing task. The computing system 100 may leverage an optimization model to generate the optimal processing decision. For instance, the computing system 100 may generate, using a machine learning optimization model, the optimal processing decision for an individual computing task of a multi-task process. The individual computing task, for example, may correspond to a task node of the dependency graph.

In some embodiments, the optimal processing decision is based on the individual computing task and a plurality of processing environments for the multi-task process. For example, the processing environments may include a local processing environment and a remote processing environment. In some examples, the optimal processing decision may identify the local processing environment or the remote processing environment as an optimal processing environment for the individual computing task.

In some embodiments, the local processing environment is a containerized environment configured to run the multi-task process. In some embodiments, the remote processing environment includes at least one serverless instance of a remote serverless platform.

In some embodiments, the computing system 100 generates the optimal processing decision by receiving a current local state for the local processing environment and generating, using the machine learning optimization model, the optimal processing decision for the individual computing task based on the current local state. The current local state, for example, may be indicative of at least one of a processing capability, an available memory, and/or a processing queue for the local processing environment.

In some embodiments, the computing system 100 generates the optimal processing decision by receiving a current remote state for the remote processing environment and generating, using the machine learning optimization model, the optimal processing decision for the individual computing task based on the current remote state. The current remote state, for example, may be indicative of at least one of a processing capability, an available memory, and/or a processing queue for the remote processing environment. In some examples, the current remote state may be indicative of a percentage of the processing capability currently available for the remote processing environment. By way of example, the current remote state may be indicative of a probability of instantiating a remote instance of the remote processing environment based on the individual computing task.

In some embodiments, the process 700 includes, at step/operation 710, assigning the computing task to a processing environment. For example, the computing system 100 may assign the computing task to the processing environment based on the optimal processing decision. Once assigned, the computing task may be executed using one or more resources of the processing environment. The process 700 may then return to step/operation 706 to identify another, unexecuted computing task of the multi-task process based on the dependency graph. This process may be repeated for each computing task of the multi-task process until a process result for the entire multi-task process is generated.

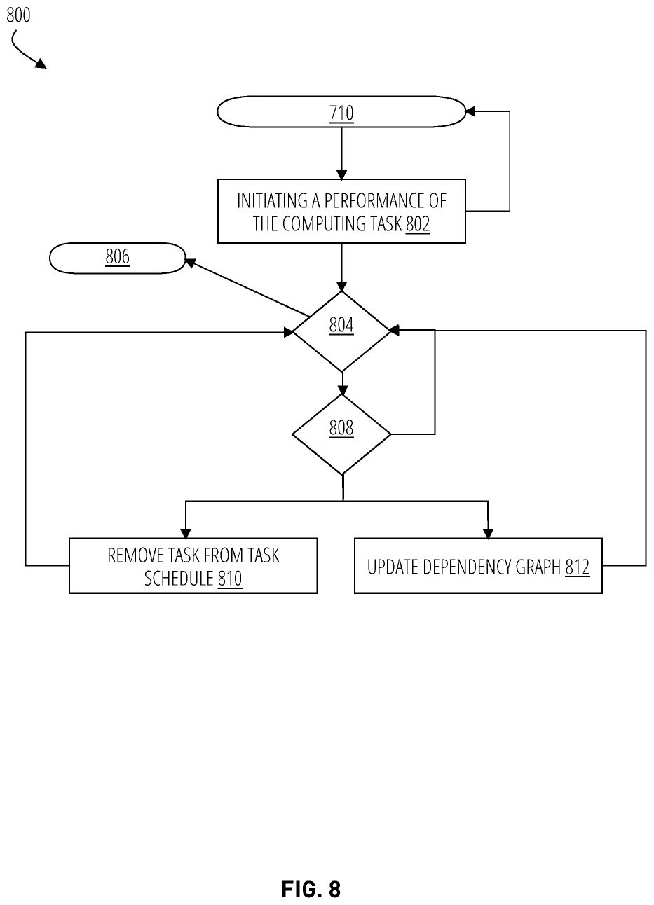

FIG. 8 is a flowchart showing an example of a process 800 for generating a process result for a multi-task process in accordance with some embodiments discussed herein. The flowchart depicts a second stage of a task processing orchestration technique that overcomes various limitations, such as processing inefficiencies, that are associated with traditional process orchestration techniques. The second stage of the task processing orchestration techniques may be implemented by one or more computing devices, entities, and/or systems described herein. For example, via the various steps/operations of the process 800, the computing system 100 may overcome the various limitations with conventional process orchestration techniques that underutilize, overload, and/or otherwise inefficiently use multiple disparate computing resources.

FIG. 8 illustrates an example process 800 for explanatory purposes. Although the example process 800 depicts a particular sequence of steps/operations, the sequence may be altered without departing from the scope of the present disclosure. For example, some of the steps/operations depicted may be performed in parallel or in a different sequence that does not materially impact the function of the process 800. In other examples, different components of an example device or system that implements the process 800 may perform functions at substantially the same time or in a specific sequence.

In some embodiments, the process 800 includes a plurality of steps/operations subsequent to the step/operation 710 of process 700, where the process 700 includes assigning a computing task to a processing environment. In some examples, the process 800 may include one or more suboperations of step/operation 710.

In some embodiments, the process 800 includes, at step/operation 802, initiating the performance of the computing task in the task schedule. For example, the computing system 100 may initiate the performance of the individual computing task based on the optimal processing decision generated for the task. By way of example, the performance of the computing task may be initiated by providing data indicative of the computing task (e.g., one or more task parameters, input parameters, etc.) to a remote processing environment. In addition, or alternatively, the performance of the computing task may be initiated locally by executing one or more task services of the computing task in a local processing environment.

In some embodiments, the process 800 includes, at step/operation 804, determining whether the task schedule includes a computing task. For example, the computing system 100 may determine that the task schedule is empty and/or that the task schedule includes at least one unexecuted computing task.

In some embodiments, in response to a determination that the task schedule is empty, the process 800 includes, at step/operation 806, generating a process result. For example, the computing system 100 may generate a process result for the multi-task process. The process result may include a final output of the multi-task process.

In some embodiments, in response to a determination that the task schedule includes at least one unexecuted computing task, the process 800 includes, at step/operation 808, detecting a task execution. For example, the computing system 100 may detect that a computing task has been executed at a local processing environment and/or remote processing environment. In the absence of a detection that a computing task has been executed, the process 800 may return to step/operation 804.

In some embodiments, in response to the detection that the computing task has been executed, the process 800 includes, at step/operation 810, removing the computing task from the task schedule. For example, the computing system 100 may remove the computing task from the task schedule and return to step/operation 804.

In some embodiments, in response to the detection that the computing task has been executed, the process 800 includes, at step/operation 812, updating the dependency graph. For example, the computing system 100 may update the dependency graph by removing a task node corresponding to the computing task and return to step/operation 804.

### VI. Conclusion

Many modifications and other embodiments will come to mind to one skilled in the art to which the present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

### VII. Examples

Example 1. A computer-implemented method for load balancing of a multi-task process, the computer-implemented method comprising: generating, by one or more processors and using an optimization model, an optimal processing decision for an individual computing task of the multi-task process, wherein: (a) the optimal processing decision is based on the individual computing task and a plurality of processing environments for the multi-task process, (b) the plurality of processing environments comprises a local processing environment and a remote processing environment, and (c) the optimal processing decision identifies the local processing environment or the remote processing environment as an optimal processing environment for the individual computing task; and initiating, by the one or more processors, the performance of the individual computing task based on the optimal processing decision.

Example 2. The computer-implemented method of example 1 further comprising: receiving, by the one or more processors, a dependency graph for the multi-task process, wherein the dependency graph comprises a plurality of task nodes corresponding to a plurality of interdependent computing tasks of the multi-task process; and identifying, by the one or more processors, the individual computing task based on the dependency graph.

Example 3. The computer-implemented method of example 2, wherein identifying the individual computing task comprises: receiving, by the one or more processors, a current graph state and one or more task dependencies for the dependency graph; and identifying, by the one or more processors, the individual computing task based on the current graph state and the one or more task dependencies.

Example 4. The computer-implemented method of any of the preceding examples, wherein the local processing environment comprises a containerized environment configured to run the multi-task process.

Example 5. The computer-implemented method of any of the preceding examples, wherein the remote processing environment comprises at least one serverless instance.

Example 6. The computer-implemented method of any of the preceding examples, wherein generating the optimal processing decision comprises: receiving, by the one or more processors, a current local state for the local processing environment; and generating, by the one or more processors and using the optimization model, the optimal processing decision for the individual computing task based on the current local state.

Example 7. The computer-implemented method of example 6, wherein the current local state is indicative of at least one of a processing capability, an available memory, or a processing queue for the local processing environment.

Example 8. The computer-implemented method of any of the preceding examples, wherein generating the optimal processing decision comprises: receiving, by the one or more processors, a current remote state for the remote processing environment; and generating, by the one or more processors and using the optimization model, the optimal processing decision for the individual computing task based on the current remote state.

Example 9. The computer-implemented method of example 8, wherein the current remote state is indicative of a probability of instantiating a remote instance of the remote processing environment based on the individual computing task.

Example 10. The computer-implemented method of examples 8 or 9, wherein the current remote state is indicative of at least one of a processing capability, an available memory, or a processing queue for the remote processing environment.

Example 11. The computer-implemented method of example 10, wherein the current remote state is indicative of a percentage of the processing capability currently available for the remote processing environment.

Example 12. The computer-implemented method of any of the preceding examples, wherein: the individual computing task comprises one or more task parameters, the one or more task parameters comprise at least one of a task identifier, one or more task services, and one or more task arguments, and the optimal processing decision is based on the one or more task parameters.

Example 13. A computing apparatus for load balancing of a multi-task process, the computing apparatus comprising memory and one or more processors communicatively coupled to the memory, the one or more processors configured to: generate, using an optimization model, an optimal processing decision for an individual computing task of the multi-task process, wherein: (a) the optimal processing decision is based on the individual computing task and a plurality of processing environments for the multi-task process, (b) the plurality of processing environments comprises a local processing environment and a remote processing environment, and (c) the optimal processing decision identifies the local processing environment or the remote processing environment as an optimal processing environment for the individual computing task; and initiate the performance of the individual computing task based on the optimal processing decision.

Example 14. The computing apparatus of example 13, wherein the one or more processors are further configured to: receive a dependency graph for the multi-task process, wherein the dependency graph comprises a plurality of task nodes corresponding to a plurality of interdependent computing tasks of the multi-task process; and identify the individual computing task based on the dependency graph.

Example 15. The computing apparatus of examples 13 or 14, wherein the local processing environment comprises a containerized environment configured to run the multi-task process.

Example 16. The computing apparatus of examples 13 through 15, wherein the remote processing environment comprises a serverless instance.

Example 17. The computing apparatus of examples 13 through 16, wherein generating the optimal processing decision comprises: receiving a current local state for the local processing environment; and generating, using the optimization model, the optimal processing decision for the individual computing task based on the current local state.

Example 18. The computing apparatus of example 17, wherein generating the optimal processing decision comprises: receiving a current remote state for the remote processing environment; and generating, using the optimization model, the optimal processing decision for the individual computing task based on the current local state and the current remote state.

Example 19. The computing apparatus of example 18, wherein the current local state is indicative of at least one of a first processing capability, a first available memory, or a first processing queue for the local processing environment, and wherein the current remote state is indicative of at least one of a second processing capability, a second available memory, or a second processing queue for the remote processing environment.

Example 20. One or more non-transitory computer-readable storage media including instructions for load balancing of a multi-task process that, when executed by one or more processors, cause the one or more processors to: generate, using an optimization model, an optimal processing decision for an individual computing task of the multi-task process, wherein: (a) the optimal processing decision is based on the individual computing task and a plurality of processing environments for the multi-task process, (b) the plurality of processing environments comprises a local processing environment and a remote processing environment, and (c) the optimal processing decision identifies the local processing environment or the remote processing environment as an optimal processing environment for the individual computing task; and initiate the performance of the individual computing task based on the optimal processing decision.

1. A computer-implemented method for load balancing of a multi-task process, the computer-implemented method comprising:
generating, by one or more processors and using an optimization model, an optimal processing decision for an individual computing task of the multi-task process, wherein:
(a) the optimal processing decision is based on the individual computing task and a plurality of processing environments for the multi-task process,
(b) the plurality of processing environments comprises a local processing environment and a remote processing environment, and
(c) the optimal processing decision identifies the local processing environment or the remote processing environment as an optimal processing environment for the individual computing task; and
initiating, by the one or more processors, the performance of the individual computing task based on the optimal processing decision.

2. The computer-implemented method of claim 1 further comprising:
receiving, by the one or more processors, a dependency graph for the multi-task process, wherein the dependency graph comprises a plurality of task nodes corresponding to a plurality of interdependent computing tasks of the multi-task process; and
identifying, by the one or more processors, the individual computing task based on the dependency graph.

3. The computer-implemented method of claim 2, wherein identifying the individual computing task comprises:
receiving, by the one or more processors, a current graph state and one or more task dependencies for the dependency graph; and
identifying, by the one or more processors, the individual computing task based on the current graph state and the one or more task dependencies.

4. The computer-implemented method of claim 1, wherein the local processing environment comprises a containerized environment configured to run the multi-task process.

5. The computer-implemented method of claim 1, wherein the remote processing environment comprises at least one serverless instance.

6. The computer-implemented method of claim 1, wherein generating the optimal processing decision comprises:
receiving, by the one or more processors, a current local state for the local processing environment; and
generating, by the one or more processors and using the optimization model, the optimal processing decision for the individual computing task based on the current local state.

7. The computer-implemented method of claim 6, wherein the current local state is indicative of at least one of a processing capability, an available memory, or a processing queue for the local processing environment.

8. The computer-implemented method of claim 1, wherein generating the optimal processing decision comprises:
receiving, by the one or more processors, a current remote state for the remote processing environment; and
generating, by the one or more processors and using the optimization model, the optimal processing decision for the individual computing task based on the current remote state.

9. The computer-implemented method of claim 8, wherein the current remote state is indicative of a probability of instantiating a remote instance of the remote processing environment based on the individual computing task.

10. The computer-implemented method of claim 8, wherein the current remote state is indicative of at least one of a processing capability, an available memory, or a processing queue for the remote processing environment.

11. The computer-implemented method of claim 10, wherein the current remote state is indicative of a percentage of the processing capability currently available for the remote processing environment.

12. The computer-implemented method of claim 1, wherein:
the individual computing task comprises one or more task parameters,
the one or more task parameters comprise at least one of a task identifier, one or more task services, and one or more task arguments, and
the optimal processing decision is based on the one or more task parameters.

13. A computing apparatus for load balancing of a multi-task process, the computing apparatus comprising memory and one or more processors communicatively coupled to the memory, the one or more processors configured to:
generate, using an optimization model, an optimal processing decision for an individual computing task of the multi-task process, wherein:
(a) the optimal processing decision is based on the individual computing task and a plurality of processing environments for the multi-task process,
(b) the plurality of processing environments comprises a local processing environment and a remote processing environment, and
(c) the optimal processing decision identifies the local processing environment or the remote processing environment as an optimal processing environment for the individual computing task; and
initiate the performance of the individual computing task based on the optimal processing decision.

14. The computing apparatus of claim 13, wherein the one or more processors are further configured to:
receive a dependency graph for the multi-task process, wherein the dependency graph comprises a plurality of task nodes corresponding to a plurality of interdependent computing tasks of the multi-task process; and
identify the individual computing task based on the dependency graph.

15. The computing apparatus of claim 13, wherein the local processing environment comprises a containerized environment configured to run the multi-task process.

16. The computing apparatus of claim 13, wherein the remote processing environment comprises a serverless instance.

17. The computing apparatus of claim 13, wherein generating the optimal processing decision comprises:
receiving a current local state for the local processing environment; and
generating, using the optimization model, the optimal processing decision for the individual computing task based on the current local state.

18. The computing apparatus of claim 17, wherein generating the optimal processing decision comprises:
receiving a current remote state for the remote processing environment; and
generating, using the optimization model, the optimal processing decision for the individual computing task based on the current local state and the current remote state.

19. The computing apparatus of claim 18, wherein the current local state is indicative of at least one of a first processing capability, a first available memory, or a first processing queue for the local processing environment, and wherein the current remote state is indicative of at least one of a second processing capability, a second available memory, or a second processing queue for the remote processing environment.

20. One or more non-transitory computer-readable storage media including instructions for load balancing of a multi-task process that, when executed by one or more processors, cause the one or more processors to:
generate, using an optimization model, an optimal processing decision for an individual computing task of the multi-task process, wherein:
(a) the optimal processing decision is based on the individual computing task and a plurality of processing environments for the multi-task process,
(b) the plurality of processing environments comprises a local processing environment and a remote processing environment, and
(c) the optimal processing decision identifies the local processing environment or the remote processing environment as an optimal processing environment for the individual computing task; and
initiate the performance of the individual computing task based on the optimal processing decision.
